(19) United States
(12) Patent Application Publication
(10) Pub. No.: US 2021/0232738 A1
(43) Pub. Date: Jul. 29, 2021

(54) ANALYSIS DEVICE, ANALYSIS METHOD, AND RECORDING MEDIUM

(71) Applicants: NEC CORPORATION, Tokyo (JP); National Institute of Advanced Industrial Science and Technology, Tokyo (JP)

(72) Inventors: Keiichi KISAMORI, Tokyo (JP); Keisuke YAMAZAKI, Tokyo (JP)

(73) Assignees: NEC CORPORATION, Tokyo (JP); National Institute of Advanced Industrial Science and Technology, Tokyo (JP)

(21) Appl. No.: 15/734,913

(22) PCT Filed: Jun. 7, 2019
(86) PCT No.: PCT/JP2019/022710

§ 371 Date: Dec. 3, 2020

(30) Foreign Application Priority Data
Jun. 7, 2018 (JP) 2018-109879

(51) Int. Cl. G06F 30/27; G06N 5/02

(52) U.S. Cl. CPC G06F 30/27; G06N 5/02

(57) ABSTRACT

An analysis device includes a parameter sample data calculation unit that calculates a plurality of pieces of sample data for parameters for a simulator; a second type sample data acquisition unit that inputs, to the simulator, target data of the first type and each of the plurality of pieces of sample data for the parameters and obtains sample data of the second type for each of the plurality of pieces of sample data; and a parameter value calculation unit that calculates a weight for each of the plurality of pieces of sample data based on the difference between target data of the second type and the calculated sample data of the second type and calculates, using the calculated weight, a value for the parameters corresponding to the target data of the first type and the target data of the second type.

### TECHNICAL FIELD

The present invention relates to an analysis device, an analysis method, and a recording medium.

### BACKGROUND ART

Techniques have been proposed for making predictions by performing machine learning using observation data.

For example, Patent Document 1 describes a probability model estimation device that handles cases where training data is not acquired from one information source and cases where characteristics of information sources differ between training data and prediction target data. This probability model estimation device obtains each marginal distribution of training data and a marginal distribution of test data, generates an objective function based on a density ratio between marginal distributions of the training data and the marginal distribution, of the test data and estimates a probability model by minimizing this objective function.

In addition, Patent Document 2 describes a weather forecast system that periodically forecasts weather using a weather forecast model. This weather forecast system assimilates observation data into a weather forecast model to perform weather forecast, and changes calculation parameters used for calculation of weather forecast according to the prediction time.

Further, the prediction device described in Patent Document 3 creates a plurality of prediction models and creates a residual prediction model that predicts residuals for each prediction model. This prediction device combines the prediction value by each prediction model with the residual prediction value by the residual prediction model to calculate a prediction value as a prediction device.

### PRIOR ART DOCUMENTS

### Patent Document

[Patent Document 1] Re-publication of PCT International Publication No. 2012/165517

[Patent Document 2] Japanese Unexamined Patent Application, First Publication No. 2008-008772

[Patent Document 3] Japanese Unexamined Patent Application, First Publication No. 2005-135287

### SUMMARY OF THE INVENTION

### Problem to be Solved by the Invention

In addition to a device that makes predictions based on observation data, with respect to a target value indicated by a user, it is preferable to have a device that can present conditions for achieving that target value to the user. For example, when tuning a production line equipped with multiple devices, if one knows which device requires what level of performance to secure target production volume, it is possible to take countermeasures that change the device settings according to the required performance, or replace devices.

One example object of the present invention is to provide an analysis device, an analysis method, and a program that can solve the aforementioned issues.

### Means for Solving the Problems

According to a first example aspect of the present invention, an analysis device includes: a parameter sample data calculation unit that calculates a plurality of pieces of sample data for parameters for a simulator, based on a temporarily set distribution for the parameters, the simulator receiving inputs of data of a first type and outputting data of a second type; a second type sample data acquisition unit that inputs, to the simulator, target data of the first type indicating a target value for the data of the first type and each of the plurality of pieces of sample data for the parameters and obtains sample data of the second type for each of the plurality of pieces of sample data for the parameters; and a parameter value calculation unit that calculates a weight for each of the plurality of pieces of sample data for the parameters based on the difference between target data of the second type indicating a target value for the data of the second type and the calculated sample data of the second type and calculates, using the calculated weight, a value for the parameters corresponding to the target data of the first type and the target data of the second type.

According to a second example aspect of the present invention, an analysis method includes the steps of calculating a plurality of pieces of sample data for parameters for a simulator, based on a temporarily set distribution for the parameters, the simulator receiving inputs of data of the first type and outputting data of the second type; inputting, to the simulator, target data of the first type indicating a target value for data of the first type and each of the plurality of pieces of sample data for the parameters and obtaining sample data of the second type for each of the plurality of pieces of sample data for the parameters; calculating a weight for each of the plurality of pieces of sample data for the parameters based on the difference between of target data of the second type indicating a target value for the data of the second type and the calculated sample data of the second type; and calculating, using the calculated weight, a value for the parameters corresponding to target data of the first type and the target data of the second type.

According to a third example aspect of the present invention, a recording medium records a program for causing a computer to execute the steps of calculating a plurality of pieces of sample data for parameters for a simulator, based on a temporarily set distribution for the parameters, the simulator receiving inputs of data of the first type and outputting data of the second type; inputting, to the simulator, target data of the first type indicating a target value for data of the first type and each of the plurality of pieces of sample data for the parameters and obtaining sample data of the second type for each of the plurality of pieces of sample data for the parameters; calculating a weight for each of the plurality of pieces of sample data for the parameters based on the difference between target data of the second type indicating a target value for the data of the second type and the calculated sample data of the second type; and calculating, using the calculated weight, a value for the parameters corresponding to the target data of the first type and the target data of the second type.

### Effect of the Invention

According to an example embodiments of the present invention, with respect to a target value indicated by a user, it is possible to present to a user conditions for realizing the target value.

### BRIEF DESCRIPTION OF THE DRAWINGS

FIG. 1 is a schematic block diagram showing an example of a functional configuration of an analysis device according to a first example embodiment.

FIG. 2 is a diagram showing an example of setting a regression function by a simulator in the first example embodiment.

FIG. 3 is a flowchart showing an example of a procedure of processing performed by the analysis device according to the first example embodiment.

FIG. 4 is a schematic block diagram showing an example of a functional configuration of an analysis device according to a second example embodiment.

FIG. 5 is a flowchart showing an example of a procedure of processing performed by the analysis device according to the second example embodiment.

FIG. 6 is a diagram showing an example of a covariate shift in the second example embodiment.

FIG. 7 is a flowchart showing an example of a procedure of processing performed by an analysis device according to a third example embodiment.

FIG. 8 is a flowchart showing an example of a procedure of processing performed by an analysis device according to a fourth example embodiment.

FIG. 9 is a diagram showing an example of the assembly process of a simulation target in an experiment according to the example embodiment.

FIG. 10 is a diagram showing relationship between X and Y obtained in the experiment according to the example embodiment.

FIG. 11 is a diagram showing values of parameters obtained by experiments according to the example embodiment.

FIG. 12 is a diagram showing an example of setting parameter values in a covariate shift experiment according to the example embodiment.

FIG. 13 is a diagram showing the relationship between X and Y obtained in the covariate shift experiment according to the example embodiment.

FIG. 14 is a diagram showing parameter values obtained in an experiment of covariate shift according to the example embodiment.

FIG. 15 is a diagram showing an example of a configuration of an analysis device according to an example embodiment of the present invention.

### EXAMPLE EMBODIMENTS

Hereinbelow, example embodiments of the present invention will be described, but the following example embodiments do not limit the invention according to the claims. Moreover, not all combinations of features described in the example embodiments are essential for the invention.

### First Example Embodiment

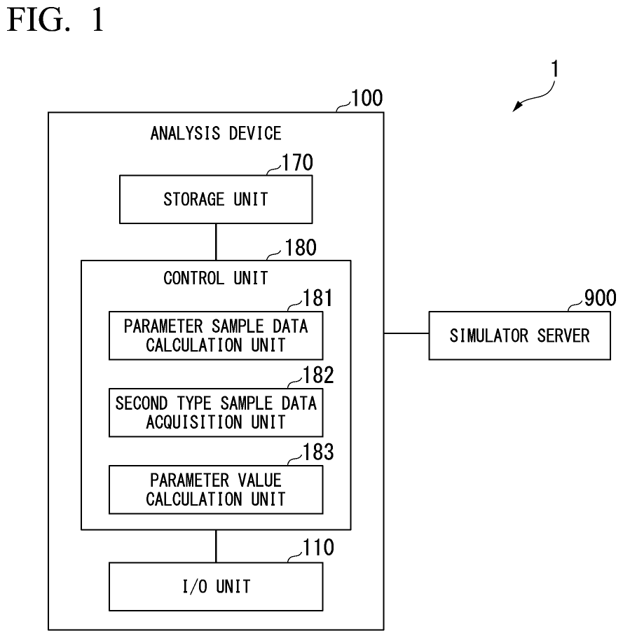

FIG. 1 is a schematic block diagram showing an example of a functional configuration of the analysis system according to the first example embodiment. In the configuration shown in FIG. 1, the analysis system 1 includes an analysis device 100 and a simulator server 900. The analysis device 100 includes an I/O unit 110, a storage unit 170, and a control unit 180. The control unit 180 includes a parameter sample data calculation unit 181, a second type sample data acquisition unit 182, and a parameter value calculation unit 183.

The analysis device 100 analyzes conditions for achieving the target value. Specifically, the analysis device 100 obtains a plurality of pieces of sample data of the target value in which are combined target data of the first type indicating a target value for the data of the first type and target data of a second type indicating a target value for data of the second type. Then, the analysis device 100 analyzes conditions for realizing the target value by analyzing relationship (for example, correlation) between the target data of the first type and the target data of the second type.

The analysis device 100 is configured using a computer such as a personal computer (PC) or a workstation.

Hereinbelow, the data of the first type will be referred to as data X, and the data of the second type will be referred to as data Y Further, the sample data of the target value in which are combined the target data of the first type and the target data of the second type will be referred to as target data. Letting the number of pieces of target data be n (n is a positive integer), vector representation of the target data of the first type as a whole is expressed as target data Xⁿ, and vector representation of the target data of the second type as a whole is expressed as target data Yⁿ. Further, elements of the target data Xⁿ are expressed as X₁, . . . , Xₙ, and elements of the target data Yⁿ are expressed as Y₁, . . . , Yₙ. As described above, the analysis device 100 obtains target data in which data Xᵢ (i is an integer of 1≤i≤n) and data Yᵢ are associated with each other on a one-to-one basis (that is, target data that can be plotted on the XY plane).

The target data Xⁿ and Yⁿ are not limited to specific types of data, and can be various data.

For example, the elements of the target data Xⁿ may represent states of constituent elements that constitute the analysis target. The elements of the target data Yⁿ may represent states that can be observed with respect to the analysis target using a sensor or the like. For example, when a user wants to analyze productivity of a manufacturing factory, the target data Xⁿ may represent the operating status of each facility in the manufacturing factory. The observation data Yⁿ may represent the number of products manufactured on a line composed of a plurality of facilities.

The analysis target and the target data are not limited to the above-mentioned examples, and may be, for example, equipment at a processing factory or a construction system in the case of constructing a certain facility.

The analysis device 100, given the target data Xⁿ and Yⁿ, the simulator r(x, θ) provided by the simulator server 900, and the distribution π(θ) that is a prior distribution temporarily set for the parameter θ, performs relationship analysis between data X and data Y. The distribution π(θ) is set, for example, by a user of the analysis device 100 with accuracy according to knowledge of the simulation target.

The simulator server 900 provides the simulator r(x, θ). The simulator r(x, θ) provided by the simulator server 900 receives setting of value of the parameter θ and input of value of data X to the variable x and outputs value of data Y Whereas in general relationship analysis a differentiable function is used as a model, the analysis device 100 the model function of the simulator r(x, θ) is not necessarily differentiable. For example, the simulator r(x, θ) is managed by a device other than the analysis device 100, such as the simulator server 900, and the analysis device 100 may transmit value of data X and value of parameter θ to this device, and receive value of data Y.

Alternatively, the analysis device 100 may include the simulator r(x, θ) inside the analysis device 100 itself In this case, the regression function of the simulator may be unknown to the analysis device 100, such as the simulator r(x, θ) being black-boxed.

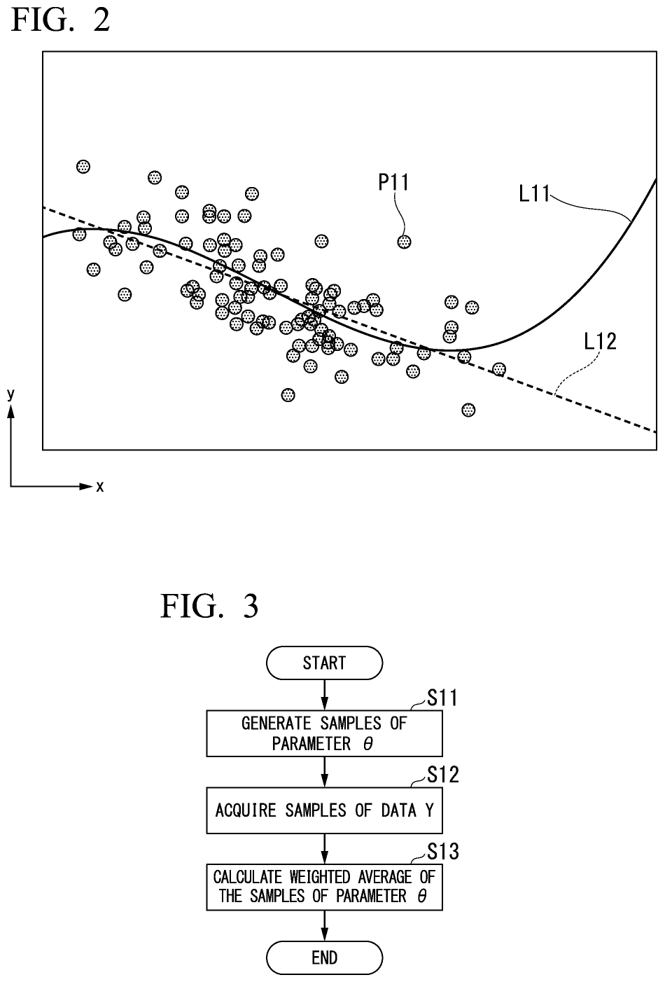

FIG. 2 is a diagram showing an example of setting a regression function by a simulator. In FIG. 2, the horizontal axis represents the X coordinate (data X coordinate), and the vertical axis represents the Y coordinate (data Y coordinate). In the following description, the term “regression function” will be used for convenience of description, but the term is not necessarily limited to a general (mathematic) “regression”. For example, “regression” is used even when the model is unclear.

Line L11 shows an ideal model. An ideal model here is a model that best represents the relationship between data X and data Y, which are the target data. For example, the ideal model curve-fits the target data with the highest accuracy. Here, the function of the ideal model is assumed to be y=R(x).

In the example of FIG. 2, the target data is indicated by circles as shown by point P11. The line L11 is a curve approximation of the target data indicated by the circles.

As described above, the ideal model (line L11) is not always represented by using a mathematical function (for example, a linear function, a quadratic function, an exponential function, a Gaussian function), and may simply represent relationship between x and y for convenience. Furthermore, the ideal model does not have to be actually represented. Hereinafter, the term “function” will be used for convenience of description, but the term “function” will be used to mean a relationship.

The line L12 shows an example of a regression function obtained as a result of performing a mathematical regression analysis on x and y, which are inputs and outputs of the simulator, respectively. The simulator r(x, θ) provided by the simulator server 900 receives setting of the value of the parameter θ and outputs data Y according to the mathematical regression function exemplified by the line L12, for example. In other words, when the value of the data X is received in this state, the simulator r(x, θ) outputs the value of the data Y corresponding to the value of the input data X. In the case where the observation target is a factory, this expresses the fact that there is a relationship that statistically follows the regression function between the data X (for example, the state of equipment) input to the simulator and the output data Y (for example, the number of manufactured lines).

The analysis device 100 calculates a parameter value corresponding to the target data based on the target data, and sets the calculated parameter value in the simulator. Thereby, the simulator outputs the value of the data Y in response to the input of the value of the data X. That is, the simulator can execute the simulation by setting the parameter value.

The regression function by the simulator may be unknown to the analysis device 100.

The I/O unit 110 performs input and output of data. In particular, the I/O unit 110 acquires target data. For example, the I/O unit 110 includes a communication device and communicates with other devices to transmit and receive data. Further, the I/O unit 110 may include an input device such as a keyboard and a mouse in addition to or instead of the communication device to receive data input by a user operation. The storage unit 170 stores various data. The storage unit 170 is configured using a storage device included in the analysis device 100.

The control unit 180 controls each unit of the analysis device 100 to execute various processes. The control unit 180 is configured by a CPU (Central Processing Unit) provided in the analysis device 100 reading a program from the storage unit 170 and executing the program.

The parameter sample data calculation unit 181 calculates a plurality of pieces of sample data of the parameter θ based on the distribution π(θ) temporarily set for the parameter θ. The distribution π(θ) may be a distribution that follows a Gaussian distribution, or may be set using uniform random numbers in a certain numerical range. However, the distribution π(θ) is not limited to these examples. As described above, the parameter θ is a parameter of the simulator r(x,θ). The simulator r(x, θ) receives a value of the data of the first type (data X) and outputs a value of the data of the second type (data Y).

The second type sample data acquisition unit 182 inputs target data of the first type (target data Xⁿ) and sample data of the parameter θ to the simulator r(x, θ), and acquires sample data of the second type (sample data of data Y) for each of the pieces of sample data of the parameter θ.

The parameter value calculation unit 183 calculates a weight for each of the pieces of sample data of the parameter θ based on a difference between the target data of the second type (target data Yⁿ) and the sample data of the second type (the sample data of the data Y) acquired by the second type sample data acquisition unit 182, and calculates a value of the parameter θ using the obtained weight.

The value of the parameter θ calculated by the parameter value calculation unit 183 indicates a condition for realizing the target value indicated by the target data. For example, in a product assembling process in which an assembling device and an inspection device operate, the target value of the product production amount per unit time is set to the data X, and the target value of the shipping time of the number of products indicated by the data X is set as the data Y Further, working time of the assembling device and working time of the inspection device are used as parameters of the simulator. The analysis device 100 tunes the parameters so that when the simulator has output the target value of the product shipping time (data Y) in response to the input of the target value of the product production amount per unit time (data X), the parameter value indicates the working time of the assembling device and the working time of the inspection device for realizing these target values.

The value of the parameter θ calculated by the parameter value calculation unit 183 is a value determined by the analysis device 100 as an appropriate value of the parameter θ (a value for simulating the relationship between the data X and the data Y).

FIG. 3 is a flowchart showing an example of a procedure of processing performed by the analysis device 100 according to the first example embodiment. (Step

### S11)

The parameter sample data calculation unit 181 generates sample data θ^{<1>}ⱼ of the parameter θ based on a prior distribution of the parameter θ (distribution π(θ. <1> indicates data based on the prior distribution.

With the number of pieces of data to be generated being m (m is a positive integer), and j being an integer of 1≤j≤m, θ^{<1>}ⱼ is expressed as in Expression (1).

[Expression 1]

θ^{<1>}ⱼ∈ Real^{d}^{_{θ}}˜π(θ) (1)

d_{θ} denotes the number of dimensions of the parameter θ.

As shown in Expression (1), θ^{<1>}ⱼ is represented as a de-dimensional real number and follows the distribution π(θ). The optimum parameter value is unknown at this point, and for example, a user estimates the distribution of the parameter θ based on obtained information and registers it as the prior distribution π(θ).

After Step S11, the process proceeds to Step S12.

### (Step S12)

The second type sample data acquisition unit 182 acquires the sample data Y^{<1>n}ⱼ corresponding to the target data Xⁿ for each sample data θ^{<1>}ⱼ obtained in Step S11. The second type sample data acquisition unit 182 inputs θ^{<1>}ⱼ and Xⁿ to the simulator r(x, θ) and acquires Y^{<1>n}ⱼ. The second type sample data acquisition unit 182 acquires the sample data Y^{<1>n}ⱼ having n (the same number as the number of elements of the target data Xⁿ) elements for each sample data θ^{<1>}ⱼ. The elements of the target data Xⁿ and the elements of the sample data Y^{<1>n}ⱼ are associated one-to-one with each other and can be plotted on the XY plane.

Y^{<1>n}ⱼ is expressed as in Expression (2).

[Expression 2]

Y^{<1>n}ⱼ ∈ Realⁿ˜p(y|Xⁿ,θ^{<1>}ⱼ) (2)

As shown in Expression (2), Y^{<1>n}ⱼ is represented as an n-dimensional real number, and follows the distribution p(y|Xⁿ, θ^{<1>}ⱼ) obtained by inputting the target data Xⁿ and the sample data to the learning model p(y|x,θ) of the simulator r(x,θ).

After Step S12, the process proceeds to Step S13.

### (Step S13)

Based on Y^{<1>n}ⱼ obtained in Step S12 and the target data Yⁿ, the parameter value calculation unit 183 calculates a weight for each θ^{<1>}ⱼ and a weighted average of them.

The parameter value θ^{<2>} obtained by the weighted average is expressed as in Expression (3). <2> indicates that the data has already reflected the weight based on the comparison between Y^{<1>n}ⱼ and Yⁿ.

$$\begin{matrix}[ Expression 3 ] & \\ {θ}^{〈 2 〉} = {\sum }_{j} ( {w}_{j} {θ}_{j}^{〈 1 〉} ) & ( 3 )\end{matrix}$$

The weight wⱼ is expressed as in Expression (4).

[Expression 4]

wⱼ=k(Yⁿ,Y^{<1>n}ⱼ) (4)

k is a function that calculates the proximity (norm) between Y^{<1>n}ⱼ and Yⁿ. A Gaussian kernel can be used as k, and is represented by Expression (5).

$$\begin{matrix}[ Expression 5 ] & \\ k ( {Y}^{n} , {Y}_{j}^{〈 1 〉 n} ) = exp \{ - \frac{1}{2 {σ}^{2}} {‖ {Y}^{n} - {Y}_{j}^{〈 1 〉 n} ‖}^{2} \} & ( 5 )\end{matrix}$$

The parameter value calculation unit 183 increases the weight on the sample data θ^{<1>}ⱼ as Y^{<1>n}ⱼ and Yⁿ are closer to each other. That is, the parameter value calculation unit 183 increases the weight for the sample data θ^{<1>}ⱼ having a high likelihood (the sample data θ^{<1>}ⱼ having a high accuracy of approximating the target data Yⁿ).

After Step S13, the analysis device 100 ends the process of FIG. 3.

The analysis device 100 may update a parameter of the simulator using the weight determined by the parameter value calculation unit 183. By performing such processing, a simulation with high prediction accuracy can be achieved on the sample data of the second type.

When the parameter value calculated by the parameter value calculation unit 183 is a parameter value with which the simulator approximates the target data with high accuracy, such parameter value indicates a condition for realizing the target value indicated by the target data. That the simulator approximates the target data with high accuracy means that the output value of the simulator is close to the target data of the second type of the target data when the target data of the first type of the target data has been input to the simulator.

As described above, the parameter sample data calculation unit 181 calculates a plurality of pieces of sample data θ^{<1>}ⱼ of the parameter θ based on the distribution π(θ) temporarily set in relation to the parameter θ of the simulator r(x, θ) that receives input of the value of the data of the first type (data X) and outputs the value of the data of the second type (data Y). The second type sample data acquisition unit 182 inputs the target data Xⁿ of the first type and the sample data θ^{<1>}ⱼ of the parameter θ into the simulator r(x,θ), and acquires the sample data Y^{<1>n}ⱼ of the second type for each piece of sample data θ^{<1>}ⱼ of the parameter θ. The parameter value calculation unit 183 calculates a weight for each of the pieces of the sample data of the parameter θ based on a difference between the target data Yⁿ of the second type and the sample data Y^{<1>n}ⱼ of the second type that was calculated, and calculates the value θ^{<2>} of the parameter θ using the obtained weight.

When the parameter value calculated by the parameter value calculation unit 183 is a parameter value with which the simulator approximates the target data with high accuracy, this parameter value indicates a condition for realizing the target value indicated by the target data.

By presenting this parameter value to a user, the analysis device 100 can present to the user the condition for realizing that target value with respect to the target value indicated by the user.

In the analysis device 100, by generating the sample data θ^{<1>}ⱼ of the parameter θ of the simulator and inputting the generated sample data θ^{<1>}ⱼ to the simulator to be evaluated, it is possible to determine the value of the parameter θ without having to differentiate a model function. The analysis device 100 can perform relationship analysis even when the model function is not differentiable or when the model is unknown.

### Second Example Embodiment

In the first example embodiment, an estimation value of the parameter θ is obtained as a real values with having the d_{θ} dimension. On the other hand, in the second example embodiment, an example of obtaining an estimation value of the parameter θ by distribution will be described.

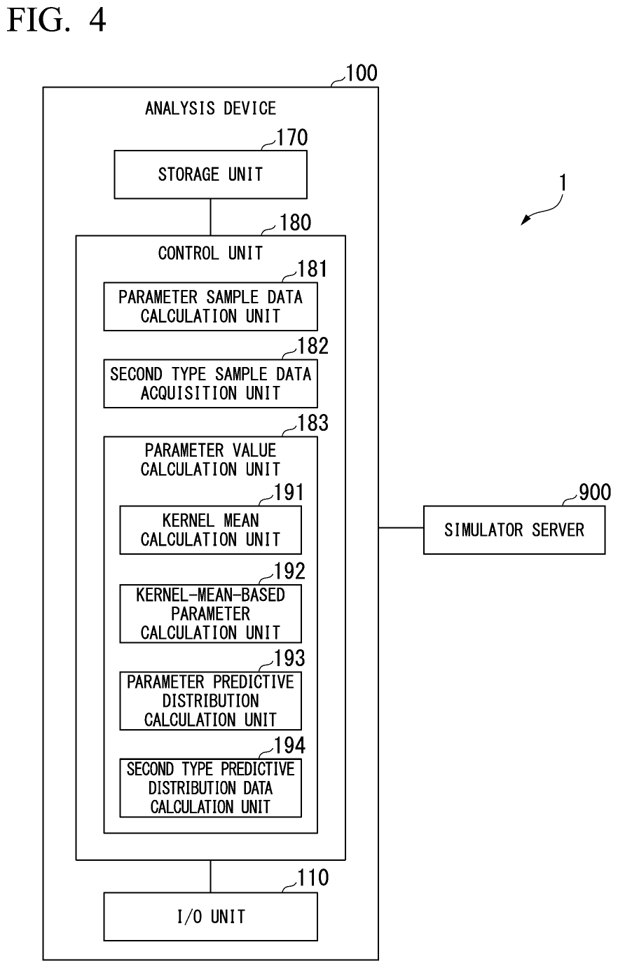

FIG. 4 is a schematic block diagram showing an example of the functional configuration of the analysis device according to the second example embodiment. A configuration shown in FIG. 4 is different from the configuration of FIG. 1 in that the parameter value calculation unit 183 includes a kernel mean calculation unit 191, a kernel-mean-based parameter calculation unit 192, a parameter predictive distribution calculation unit 193, and a second type predictive distribution data calculation unit 194. The other configuration is similar to the case of FIG. 1.

The kernel mean calculation unit 191 calculates a kernel mean that indicates the posterior distribution of the parameter θ under the target data Xⁿ of the first type and the sample data Y^{<1>n}ⱼ of the second type acquired by the second type sample data acquisition unit 182.

The kernel-mean-based parameter calculation unit 192 calculates sample data of the parameter θ based on the kernel mean calculated by the kernel mean calculation unit 191.

The parameter predictive distribution calculation unit 193 calculates the kernel expression of the predictive distribution of the parameter θ by using the sample data of the parameter θ based on the kernel mean calculated by the kernel mean calculation unit 191.

The second type predictive distribution data calculation unit 194 calculates sample data according to the predictive distribution of the data of the second type (data Y) using the kernel expression of the predictive distribution of the parameters calculated by the parameter predictive distribution calculation unit 193.

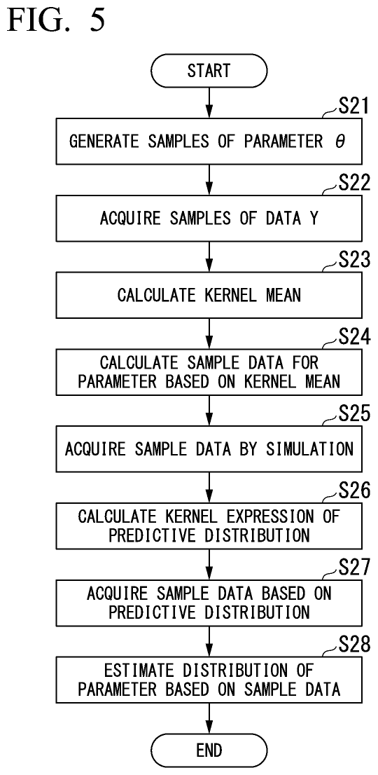

FIG. 5 is a flowchart showing an example of the processing procedure performed by the analysis device 100 according to the second example embodiment.

Steps S21 to S22 in FIG. 5 are the same as steps S11 to S12 in FIG. 3. After Step S22, the processing proceeds to Step S23.

### (Step S23)

The kernel mean calculation unit 191 calculates the kernel mean.

The above Expression (3) can be expressed as Expression (6) by considering it as a formula for calculating the kernel mean. The kernel mean calculation unit 191 calculates the kernel mean μ\hat{ }_{θ|XY} based on Expression (6).

$$\begin{matrix}[ Expression 6 ] & \\ {μ}_{θ \vert YX}^{⋀} = {\sum }_{j = 1}^{m} {w}_{j} {θ}_{j}^{〈 1 〉} & ( 6 )\end{matrix}$$

The weight wⱼ is expressed as in Expression (7).

$$\begin{matrix}[ Expression 7 ] & \\ w = {( {w}_{1} , … , {w}_{m} )}^{T} ∈ {Real}^{m} = {( G + m δ I )}^{- 1} {k}_{y} ( {Y}^{n} ) & ( 7 )\end{matrix}$$

Superscript T indicates transpose of matrix or vector.

k_{y} is shown as in Expression (8).

[Expression 8]

k_{y}(Yⁿ)=(k_{y}(Y^{<1>n}ⱼ, Yⁿ), . . . , k_{y}(Y^{<1>n}ₘ, Yⁿ))^{T} ∈ Real^{m} (8)

As k_{y}, the Gaussian kernel function shown in Expression (9) is used.

$$\begin{matrix}[ Expression 9 ] & \\ {k}_{y} ( {Y}^{n} , {Y}^{n ′} ) = exp \{ - \frac{1}{2 {σ}^{2}} {‖ {Y}^{n} - {Y}^{n ′} ‖}^{2} \} ∈ {Real}^{1} & ( 9 )\end{matrix}$$

G denotes the Gramm matrix and is expressed as in Expression (10).

[Expression 10]

G=(k_{y}(Y^{<1>n}ⱼ, Y^{<1>n}_{j′}))_{j,j′=1}^{m} ∈ Real^{m×m} (10)

The kernel mean μ\hat{ }_{θ|XY} corresponds to the posterior distribution of θ under X and Y expressed in the Reproducing Kernel Hilbert Space (RKHS) by kernel mean embeddings.

After Step S23, the process proceeds to Step S24.

### (Step S24)

The kernel-mean-based parameter calculation unit 192 calculates sample data {θ^{<3>}₁, . . . , θ^{<3>}ₘ} (m being a positive integer indicating the sample number) based on the kernel mean μ\hat{ }_{θ|XY} for the parameter θ. <3> indicates that data is based on the kernel mean.

Sample data based on the kernel mean can be recursively obtained using the kernel herding method. In this case, j is 0≤j≤m (m being a positive integer indicating the sample number), and the kernel-mean-based parameter calculation unit 192 calculates the sample data θ^{<3×}ⱼ₊₁ based on Expression (11).

[Expression 11]

θ^{<3>}ⱼ₊₁=argmax_{θ}hⱼ(θ) (11)

argmax_{θ}hⱼ(θ) indicates the value of θ that maximizes the value of hⱼ(θ).

hⱼ is recursively indicated by Expression (12).

[Expression 12]

hⱼ₊₁=hⱼ+μ−θ^{<3>}ⱼ₊₁ ∈ H (12)

Input the kernel mean μ\hat{ }θ_{|XY} obtained in Step S23 into μ of Expression (12). Further, the initial value h₀ of hⱼ is set to h₀:μ\hat{ }_{θ|XY}.

H denotes the reproducing kernel Hilbert space.

Weight according to the closeness (norm) between the sample data Y^{<1>n}ⱼ based on the prior distribution and the target data Yⁿ is reflected in the sample data {θ^{<3>}₁, . . . , θ^{<3>}ₘ} obtained in Step S24.

After Step S24, the process proceeds to Step S25.

### (Step S25)

The parameter predictive distribution calculation unit 193 inputs the target data Xⁿ and the sample data θ^{<2>}ⱼ to the simulator r(x,θ) to calculate by simulation {θ^{<3>}ⱼ, Y^{<3>n}ⱼ} according to the distribution p(y|Xⁿ, θ^{<3>}ⱼ).

After Step S25, the process proceeds to Step S26.

### Step S26)

The parameter predictive distribution calculation unit 193 uses the sample data {θ^{<3>}ⱼ, Y^{<3>n}ⱼ} obtained in Step S25 to calculate the kernel representation v\hat{ }_{y|XY} of the predictive distribution of the data Y.

The kernel representation v\hat{ }_{y|YX} of the predictive distribution can be calculated using the Kernel Sum Rule. In this case, the predictive distribution p(y|Xₙ, Yₙ) is represented by Expression (13).

[Expression 13]

p(y|Xⁿ, Yⁿ)=∫p(y|Xⁿ, θ)p(θ|Xⁿ, Yⁿ)d_{θ} (13)

The kernel expression v\hat{ }_{y|YX} of the predictive distribution p(y|Xₙ, Yₙ) is given as in Expression (14).

$$\begin{matrix}[ Expression 14 ] & \\ {v}_{y \vert XY}^{⋀} = {\sum }_{j = 1}^{m} {v}_{j} {Y}_{j}^{〈 3 〉 n} & ( 14 )\end{matrix}$$

v₁, . . . , vₘ are shown as in Expression (15).

$$\begin{matrix}[ Expression 15 ] & \\ v = {( {v}_{1} , … , {v}_{m} )}^{T} ∈ {Real}^{m} = {( {G}_{{θ}^{〈 3 〉}} + m {δ}_{m} I )}^{- 1} {G}_{{θ}^{〈 3 〉} θ} {w}^{T} & ( 15 )\end{matrix}$$

The Gram matrix G_{θ<3>} is expressed as in Expression (16).

[Expression 16]

G_{θ}_{^{<3>}}=(k_{θ}(θ^{<3>}ⱼ, θ^{<3>}_{j′}))_{j,j′=1}^{m} (16)

The Gram matrix G_{θ<3>θ} is expressed as in Expression (17).

[Expression 17]

G_{θ}_{^{<3>}}_{θ}=(k_{θ}(θ^{<3>}ⱼ, θ_{j′}))_{j,j′=1}^{m} (17)

δₘ is a coefficient for stabilizing calculation of the inverse matrix.

I indicates the identity matrix.

After Step S26, the process proceeds to Step S27.

### (Step S27)

The second type predictive distribution data calculation unit 194 obtains sample data Y^{<4>n}ⱼ based on the predictive distribution using the kernel expression v\hat{ }_{y|YX} of the predictive distribution obtained in Step S26.

<4> indicates that data is based on the kernel expression of the predictive distribution.

Also in Step S27, sample data can be recursively obtained using the kernel herding method, as in Step S24. In Step S27, the sample data is calculated based on Expression (18).

[Expression 18]

Y^{<4>}ⱼ₊₁=argmax_{y}h′ⱼ(y) (18)

argmax_{y}hⱼ(y) indicates the value of y that maximizes the value of hⱼ(y).

h′ⱼ is recursively shown by Expression (19).

[Expression 19]

h′ⱼ₊₁=h′ⱼ+v−Y^{<4>}ⱼ₊₁ ∈ H (19)

The kernel expression v\hat{ }_{y|XY} of the predictive distribution obtained in Step S26 is input into v of Expression (19). Further, the initial value h′₀ of h′j is set to h′₀:=v\hat{ }_{y|YX}.

After Step S27, the process proceeds to Step S28.

### (Step S28)

The second type predictive distribution data calculation unit 194 calculates the distribution of the parameter θ based on the sample data {θ^{<3>}₁, . . . , θ^{<2>}ₘ} obtained in Step S24. For example, the second type predictive distribution data calculation unit 194 assumes that the distribution of the parameter θ follows a specific distribution such as a Gaussian distribution, and calculates characteristic amounts of the distribution such as the average value and the variance based on the sample data.

Alternatively, the analysis device 100 may present the sample data of the parameter obtained in Step S24 to a user as is (for example, display in a graph). By referring to the sample data itself of the parameter, the user can determine confidence interval and reliability of the parameter itself calculated by the kernel-mean-based parameter calculation unit 192 with higher accuracy. In addition, when the sample data of the parameter cannot be captured with a specific distribution, for example, when the parameter distribution is multimodal or when the parameter distribution is asymmetric, the user can ascertain the distribution of the parameter by the analysis device 100 presenting the sample data of the parameter to the user as is.

The second type predictive distribution data calculation unit 194 may calculate the distribution of the sample data Y^{<4>n}ⱼ of the data Y obtained in Step S27, in addition to or instead of the sample data of the parameter.

After Step S28, the analysis device 100 ends the process of FIG. 5.

As described above, the kernel mean calculation unit 191 calculates the kernel mean μ\hat{ }_{θ|XY} indicating the posterior distribution of parameter θ under the of target data Xⁿ of the first type and the sample data Y^{<1>n}ⱼ of the second type acquired by the second type sample data acquisition unit 182. The kernel-mean-based parameter calculation unit 192 calculates the sample data {θ^{<3>}₁, . . . , θ^{<2>}ₘ} of the parameter θ based on the kernel mean μ\hat{ }_{θ|XY} calculated by the kernel mean calculation unit 191. The parameter predictive distribution calculation unit 193 calculates the kernel expression v\hat{ }_{y|XY} of the predictive distribution of the data Y using the sample data {θ^{<3>}₁, . . . , θ^{<2>}ₘ} of the parameter θ. The second type predictive distribution data calculation unit 194 calculates the sample data Y^{<4<n}ⱼ that follows the predictive distribution of the data of the second type (data Y) using the kernel expression v\hat{ }_{y|YX} of the predictive distribution of the data Y calculated by the parameter predictive distribution calculation unit 193.

By thus generating the sample data by the analysis device 100, the data distribution can be found from the sample data. The analysis device 100 may calculate the data distribution. Alternatively, the analysis device 100 may present the sample data to a user, and the user may find the data distribution.

As described above, according to the analysis device 100, the user can know not only a value of the condition (parameter value) for realizing the target data, but also a distribution (for example, variance). Thereby, the user can also consider how much margin is expected in order to realize the target value with respect to the condition presented by the analysis device 100.

### Third Example Embodiment

In the third example embodiment, a case where the analysis device is compatible with covariate shift will be described. Covariate shift means that input and output functions do not change even though the distribution of inputs differs between training and testing. Here, the case where the distribution of the data X of the target data (target data of the first type) and the distribution of the data X of the relationship analysis target (range to be analyzed) differ but the ideal model does not change is treated as a covariate shift. The distribution of the data X of the target data is expressed as q₀(x), and the distribution of the data X of the relationship analysis target is expressed as q₁(x).

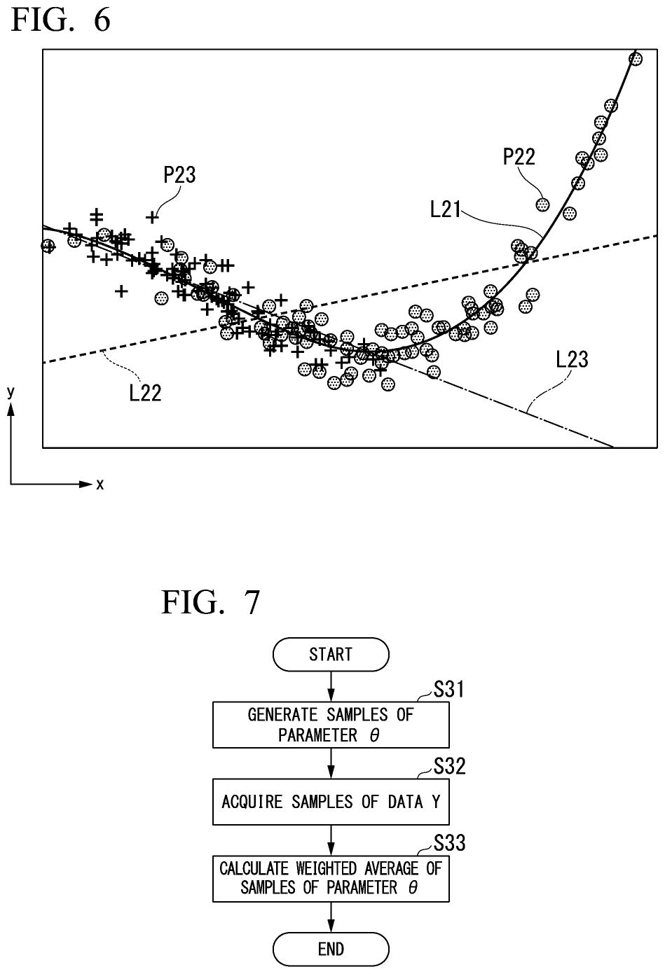

FIG. 6 is a diagram showing an example of covariate shift. In FIG. 6, the horizontal axis represents X coordinate (data X coordinate), and the vertical axis represents Y coordinate (data Y coordinate).

The line L21 shows the ideal model. Here, the function of the ideal model is assumed to be y=R(x).

Also, both the data indicated by a circle like the point P22 and the data indicated by a cross like the point P23 are generated based on the ideal model. Data indicated by circles are called circle data, and data indicated by crosses are called cross data.

In the example of FIG. 6, noise is included in the data, and both the circle data and cross data are plotted near the line L21.

On the other hand, the circle data and the cross data have different distributions in the X-axis direction. The circle data are widely distributed to the left and right in FIG. 6, while the cross data are distributed on the left side of FIG. 6. Due to this difference in distribution, regression functions differ between the circle data and the cross data. For example, when linear regression is performed, the regression line for the circle data is line L22, while the regression line for the cross data is line L23.

In this way, even if the ideal model is the same, the regression functions may differ due to the difference in the distributions. For example, in the case of the obtained target data being circle data, when the regression function is found based on this target data (circle data), the line L22 is obtained. On the other hand, when the user wants to perform relationship analysis in the case of the distribution of cross data, the accuracy is low if the line L22 is used as a regression function, and so it is desired to obtain the line L23 as a regression function.

Therefore, the analysis device 100 weights the target data based on a comparison between the distribution of the data X of the target data and the distribution of the data X in the range for which the relationship analysis is to be performed, and finds the value of the parameter θ corresponding to the distribution of the data X in the range in which the relationship analysis is to be performed.

For example, the user determines the target value of the data Y (target data of the second type) in each case for various values of the data X (that is, for various patterns of the target data of the first type). In the case of the example of the product assembly process, a user, assuming various situations such as a period when a large number of orders are received and a period when the orders are small, decides a target value of the shipping time (data Y) for each product production amount (data X) per unit time.

The analysis device 100 uses, as target data, a combination of the value of the data X and the target value of the data Y set for the value of the data X for various values of the data X.

Then, the user sets the target value of the data X according to the situation. In the case of the example of the product assembling process, the user determines the target value of the product production amount per unit time according to the current order status.

The analysis device 100 calculates a parameter value with which the simulator can accurately approximate the set target value of the data X and the target value of the data Y defined in association with the target value of the data X.

The analysis device 100 calculates the parameter value by focusing not on the entire range of the data X, but on a portion of the value of the data X set by the user as the target value. The portion of the value of the data X set by the user as the target value corresponds to the relationship analysis target. Further, the analysis device 100 selectively focuses on the portion of the value of the data X set by the user as the target value by using the weight corresponding to the value of the data X.

The configuration of the analysis system and the configuration of the analysis device 100 according to the third example embodiment are the same as in the case of the first example embodiment (FIG. 1). In the third example embodiment, the process performed by the parameter value calculation unit 183 is different from that in the first example embodiment. In the third example embodiment, the parameter value calculation unit 183 calculates a weight for each of the pieces of the sample data of the parameter based on the difference between the target data Yⁿ of the second type and the sample data Y^{<1>n}₁ of the second type, and the relationship between the first distribution that the target data Xⁿ of the first type follows and the second distribution that is the distribution of the data of the first type and that indicates the region for which a relationship is sought, and calculates the value of the parameter using the obtained weight.

In the first example embodiment, the parameter value calculation unit 183 calculates the weight based on the likelihood of the parameter sample data θ^{<1>}ⱼ, which is indicated by the closeness between the target data Yⁿ and the sample data Y^{<1>n}ⱼ. In contrast, in the third example embodiment, the parameter value calculation unit 183 weights each of the pieces of the sample data θ^{<1>} based on the degree of agreement with the distribution d₁(x) of the target data in addition to the likelihood of the sample data θ^{<1>}ⱼ.

FIG. 7 is a flowchart showing an example of the processing procedure performed by the analysis device 100 according to the third example embodiment.

Steps S31 to S32 in FIG. 7 are the same as steps S11 to S12 in FIG. 3. After Step S32, the process proceeds to Step S33.

### (Step S33)

The parameter value calculation unit 183 calculates a weight for each piece of sample data θ^{<1>}ⱼ of the parameter and averages the weights. In Step S12 of FIG. 3, the parameter value calculation unit 183 calculates the weight for each θ^{<1>}ⱼ based on the sample data Y^{<1>n}ⱼ and the target data Yⁿ. In contrast, in Step S33, the parameter value calculation unit 183 calculates a weight based on the distribution q₀(x) of the target data Xⁿ and the distribution q₁(x) indicating the region where regression is sought, in addition to the sample data Y^{<1>n}ⱼ and the target data Yⁿ.

A parameter value θ^{<5>} obtained by means of weighted-averaging is expressed as in Expression (20). <5> indicates data in which weight based on Y^{<1>n}ⱼ, Yⁿ, q₀(x), and q₁(x) has been reflected.

$$\begin{matrix}[ Expression 20 ] & \\ {θ}^{〈 5 〉} = {\sum }_{j} ( {w}_{j}^{′} {θ}_{j}^{〈 1 〉} ) & ( 20 )\end{matrix}$$

The weight w′ⱼ is expressed as in Expression (21).

[Expression 21]

w′ⱼ=k′(Yⁿ, Y^{<1>n}ⱼ) (21)

k′ is a function that calculates the closeness (norm) between Y^{<1>n}ⱼ and Yⁿ, and adds the degree of coincidence to the distribution q1(x). An expression obtained by modifying a Gaussian kernel can be used as V, and is represented by Expression (22).

$$\begin{matrix}[ Expression 22 ] & \\ {k}^{′} ( {Y}^{n} , {Y}_{j}^{n ′} ) = exp \{ - \frac{1}{2 {σ}^{2}} {‖ {β}^{n} ∘ ( {Y}^{n} - {Y}_{j}^{n ′} ) ‖}^{2} \} = exp \{ - \frac{1}{2 {σ}^{2}} {\sum }_{i = 1}^{n} {( {β}_{i} ( {Y}_{i} - {Y}_{i}^{′} ) )}^{2} \} & ( 22 )\end{matrix}$$

βᵢ is a function indicating the degree of agreement of each element of Xⁿ with the distribution q₁(x), and is expressed as in Expression (23).

$$\begin{matrix}[ Expression 23 ] & \\ {β}_{i} = β ( {X}_{i} ) = \frac{{q}_{1} ( {X}_{i} )}{{q}_{0} ( {X}_{i} )} & ( 23 )\end{matrix}$$

The white circle operator indicates a Hadamard product, that is, an elementwise product of a matrix or vector.

After Step S13, the analysis device 100 ends the process of FIG. 7.

As described above, the parameter sample data calculation unit 181 calculates a plurality of pieces of sample data θ^{<1>}ⱼ of the parameter θ based on the distribution π(θ) temporarily set in relation to the parameter θ of the simulator r(x, θ) that receives input of the value of the data of the first type (data X) and outputs the value of the data of the second type (data Y). The second type sample data acquisition unit 182 inputs the target data Xⁿ of the first type and the sample data θ^{<1>}ⱼ of the parameter θ into the simulator r(x,θ), and acquires the sample data Y^{<1>n}ⱼ of the second type for each piece of sample data θ^{<1>}ⱼ of the parameter θ. The parameter value calculation unit 183 calculates a weight for each of the pieces of the sample data of the parameter θ based on the difference between the target data Yⁿ of the second type and the sample data Y^{<1>n}ⱼ of the second type that was calculated, and the relationship between the first distribution q₀(x) that the target data Xⁿ of the first type follows and the second distribution q₁(x) that is the distribution of the data of the first type and that is on the region for which a relationship is sought, and calculates the value of the parameter θ using the obtained weight.

Thereby, the analysis device 100 can perform relationship analysis with higher accuracy in response to a covariate shift. Therefore, the analysis device 100 can calculate the condition (parameter value) for realizing the target value indicated by the user with higher accuracy. That is, according to the analysis device 100, the condition for realizing the target value can be presented to a user in response to the change of the target value depending on the situation.

### Fourth Example Embodiment

In the third example embodiment, the estimation value of the parameter θ is obtained as a real value in the do dimension. In contrast, in the fourth example embodiment, an example of obtaining the estimation value of the parameter θ by distribution will be described.

The configuration of the analysis system and the configuration of the analysis device 100 according to the fourth example embodiment are the same as in the case of the second example embodiment (FIG. 4). In the fourth example embodiment, the process performed by the parameter value calculation unit 183 is different from that in the first example embodiment. In the third example embodiment, the parameter value calculation unit 183 calculates a weight for each of the pieces of the sample data of the parameter based on the difference between the target data Yⁿ of the second type and the sample data Y^{<1>n}ⱼ of the second type, and the relationship between the first distribution that the target data Xⁿ of the first type follows and the second distribution that is the distribution of the data of the first type and that is on the region for which a relationship is sought, and calculates the value of the parameter using the obtained weight.

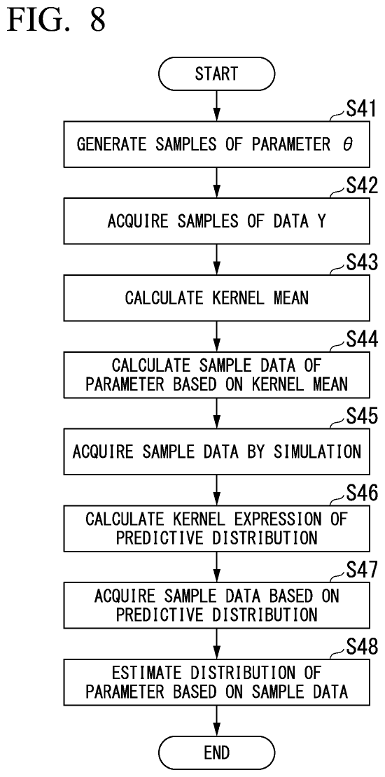

FIG. 8 is a flowchart showing an example of the processing procedure performed by the analysis device 100 according to the fourth example embodiment.

Steps S41 to S42 are the same as steps S11 to S12 in FIG. 2.

After Step S42, the process proceeds to Step S43.

### (Step S43)

The kernel mean calculation unit 191 calculates the kernel mean.

The above Expression (20) can be expressed as Expression (24) by considering it as an Expression for calculating the kernel mean. The kernel mean calculation unit 191 calculates the kernel mean μ\hat{ }_{θ<6>|XY} based on Expression (24). <6> indicates that the data is weighted based on the degree of conformance with the distribution q₁(x).

$$\begin{matrix}[ Expression 24 ] & \\ {μ}_{{θ}^{〈 6 〉} \vert YX}^{⋀} = {\sum }_{j = 1}^{m} {w}_{j}^{〈 6 〉} {θ}_{j}^{〈 1 〉} & ( 24 )\end{matrix}$$

The weight w^{<6>}ⱼ is expressed as in Expression (25).

$$\begin{matrix}[ Expression 25 ] & \\ {w}^{〈 6 〉} = {( {w}_{1}^{〈 6 〉} , … , {w}_{m}^{〈 6 〉} )}^{T} ∈ {Real}^{m} = {( {G}^{〈 6 〉} + m δ I )}^{- 1} {k}_{y}^{〈 6 〉} ( {Y}^{n} ) & ( 25 )\end{matrix}$$

k^{<6>}_{y}(Yⁿ) is expressed as in Expression (26).

[Expression 26]

k^{<6>}_{y}(Yⁿ)=(k^{<6>}_{y}(Y^{<1>n}₁, Yⁿ), . . . , k^{<6>}_{y}(Y^{<1>n}ₘ, Yⁿ))^{T} ∈ Real^{m} (26)

The Gram matrix G^{<6>} is expressed as in Expression (27).

[Expression 27]

G^{<6>}=(k_{y}(Y^{<1>n}ⱼ, Y^{<1>n}_{j′}))_{j,j′=1}^{m} ∈ Real^{m×m} (27)

k^{<6>}_{y}(Yⁿ, Yⁿ′) is expressed as in Expression (28).

$$\begin{matrix}[ Expression 28 ] & \\ {k}_{y}^{〈 6 〉} ( {Y}^{n} , {Y}^{n ′} ) = exp \{ - \frac{1}{2 {σ}^{2}} {‖ {Y}^{n} - {Y}^{n ′} ‖}^{2} \} = exp \{ - \frac{1}{2 {σ}^{2}} {\sum }_{i = 1}^{n} {( {β}_{i} ( {Y}_{i} - {Y}_{i}^{′} ) )}^{2} \} . & ( 28 )\end{matrix}$$

Expression (28) corresponds to the weighted kernel function.

The kernel mean μ\hat{ }_{θ<6>|XY} corresponds to the posterior distribution of θ under X and Y that which was weighted based on the degree of agreement with the distribution q₁(x) and expressed in reproducing kernel Hirbert space by kernel mean embedding.

After Step S43, the process proceeds to Step S44.

### (Step S44)

The kernel-mean-based parameter calculation unit 192, for the parameter θ^{<6>}, finds the sample data {θ^{<6>}₁, . . . , θ^{<6>}ₘ } based on the kernel mean μ\hat{ }_{θ<6>|XY}, (m being a positive integer indicating the number of samples).

Sample data based on the kernel mean can be recursively obtained using the kernel herding method. In this case, the kernel-mean-based parameter calculation unit 192 calculates the sample data θ^{<6>}ⱼ₊₁ based on Expression (29), where j is 0≤j≤m (m being a positive integer indicating the number of samples).

[Expression 29]

θ^{<6>}ⱼ₊₁=argmax_{θ}hⱼ(θ) (29)

argmax_{θ}hⱼ(θ) indicates the value of θ that maximizes the value of hⱼ(θ).

hⱼ is recursively indicated by Expression (30).

[Expression 30]

hⱼ₊₁=hⱼ+μ−θ^{<6>}ⱼ₊₁ ∈ H (30)

Input the kernel mean μ\hat{ }_{θ<6>|XY} obtained in Step S43 into μ of Expression (30). Further, the initial value h₀ of hⱼ is set to h₀:=μ\hat{ }_{θ<6>|XY}.

H denotes the reproducing kernel Hilbert space.

Weight according to the closeness between the sample data Y^{<1>n}ⱼ based on the prior distribution and the target data Yⁿ and the weight based on the degree of agreement with the distribution q₁(x) are reflected in the sample data {θ^{<6>}₁, . . . , θ^{<6>}ₘ} obtained in Step S24.

After Step S44, the process proceeds to Step S45.

### (Step S45)

The parameter predictive distribution calculation unit 193 inputs the target data Xⁿ and the sample data θ^{<6>}ⱼ to the learning model p(y|x,θ) to calculate by simulation {θ^{<6>}ⱼ, Y^{<6>n}ⱼ} according to the distribution p(y|Xⁿ, θ_mc^{v}ⱼ).

After Step S45, the process proceeds to Step S26.

### (Step S46)

The parameter predictive distribution calculation unit 193 uses the sample data {θ^{<6>}ⱼ, Y^{<6>n}ⱼ} obtained in Step S45 to calculate the kernel representation v\hat{ }_{y|XY} of the predictive distribution of the data Y corresponding to the distribution q₁(x).

The kernel representation v\hat{ }_{y|XY} of the predictive distribution can be calculated using the Kernel Sum Rule. In this case, the predictive distribution p(y|X^{<6>}ₙ, Y^{<6>}ₙ) is represented by Expression (31).

[Expression 31]

p(y|X^{<6>n}, Y^{<6>n})=∫p(y|X^{<6>n}, θ^{<6>})p(θ^{<6}>|X^{<6>n}, Y^{<6>n})dθ^{<6>} (31)

The kernel expression v\hat{ }_{y|YX} of the predictive distribution p(y|Xₙ, Yₙ) is given as in Expression (32).

$$\begin{matrix}[ Expression 32 ] & \\ {v}_{y \vert XY}^{⋀} = {\sum }_{j = 1}^{m} {v}_{j} {Y}_{j}^{〈 6 〉 n} & ( 32 )\end{matrix}$$

v₁, . . . , vₘ are shown as in Expression (33).

$$\begin{matrix}[ Expression 33 ] & \\ v = {( {v}_{1} , … , {v}_{m} )}^{T} ∈ {Real}^{m} = {( {G}_{{θ}^{〈 6 〉}} + m {δ}_{m} I )}^{- 1} {G}_{{θ}^{〈 6 〉} θ} {w}^{T} & ( 33 )\end{matrix}$$

The Gram matrix G_{θ<6>} is expressed as in Expression (34).

[Expression 34]

G_{θ}_{^{<6>}}=(k_{θ}(θ^{<6>}ⱼ, θ^{<6>}_{j′}))_{j,j′=1}^{m} (34)

The Gram matrix G_{θ<6>θ} is expressed as in Expression (35).

[Expression 35]

G_{θ}_{^{<6>}}_{θ}=(k_{θ}(θ^{<6>}ⱼ, θ_{j′}))_{j,j′=1}^{m} (35)

δₘ is a coefficient for stabilizing the calculation of an inverse matrix.

I indicates the identity matrix.

After Step S46, the process proceeds to Step S47.

### (Step S47)

The second type predictive distribution data calculation unit 194 obtains sample data of the predictive distribution Y^{<6>n}ⱼ using the kernel expression v\hat{ }_{y|YX} of the predictive distribution obtained in Step S46.

Also in Step S47, sample data can be recursively obtained using the kernel herding method, as in Step S44. In Step S47, the sample data is calculated based on Expression (36).

[Expression 36]

Y^{<6>}ⱼ₊₁=argmax_{y}h′ⱼ(y) (36)

argmax_{y}h′ⱼ(y) indicates the value of y that maximizes the value of h′ⱼ(y).

h′ⱼ is recursively shown by Expression (37).

[Expression 37]

h′ⱼ₊₁=h′ⱼ+v−Y^{<6>}ⱼ₊₁ ∈ H (37)

The kernel expression v\hat{ }_{y|YX} of the predictive distribution obtained in Step S46 is input into v of Expression (37). Further, the initial value h′₀ of h′j is set to h′ₒ:=v\hat{ }_{y|YX}.

After Step S47, the process proceeds to Step S48.

### (Step S28)

The second type predictive distribution data calculation unit 194 calculates the distribution of the parameter θ based on the sample data {θ^{<6>}₁, . . . , θ^{<6>}ₘ} obtained in Step S44. For example, the second type predictive distribution data calculation unit 194 assumes that the distribution of the parameter θ follows a specific distribution such as a Gaussian distribution, and calculates characteristic amounts of the distribution such as the average value and the variance based on the sample data.

Alternatively, the analysis device 100 may present the sample data obtained in Step S44 to a user as is (for example, display in a graph). By referring to the sample data itself, the user can determine a confidence interval and reliability of the data itself with higher accuracy. In addition, when the sample data cannot be captured with a specific distribution, such as the case of there being multiple peaks in the data or the distribution being asymmetric, the user can ascertain the distribution of the data by the analysis device 100 presenting the sample data to the user as is.

The second type predictive distribution data calculation unit 194 may calculate the distribution of the sample data Y^{<6>n}ⱼ of the data Y obtained in Step S47, in addition to or instead of the sample data of the parameter.

After Step S48, the analysis device 100 ends the process of FIG. 8.

As described above, the kernel mean calculation unit 191 calculates the kernel mean μ\hat{ }_{θ|XY} indicating the posterior distribution of parameter θ under the target data Xⁿ of the first type and the sample data Y^{<1>n}ⱼ of the second type acquired by the second type sample data acquisition unit 182. The kernel-mean-based parameter calculation unit 192 calculates the sample data {θ^{<6>}₁, . . . , θ^{<6>}ₘ} of the parameter θ based on the kernel mean μ\hat{ }_{θ|XY} calculated by the kernel mean calculation unit 191. The parameter predictive distribution calculation unit 193 calculates the kernel expression v\hat{ }_{y|YX} of the predictive distribution of the data Y using the sample data {θ^{<6>}₁, . . . , θ^{<6>}ₘ} of the parameter θ. The second type predictive distribution data calculation unit 194 calculates the sample data Y′^{<6>n}ⱼ that follows the predictive distribution of the data of the second type (data Y) using the kernel expression v\hat{ }_{y|YX} of the predictive distribution calculated by the parameter predictive distribution calculation unit193.

By thus generating the sample data by the analysis device 100, the data distribution can be found based on the sample data. The analysis device 100 may calculate the data distribution. Alternatively, the analysis device 100 may present the sample data to a user, and the user may find the data distribution.

As described above, according to the analysis device 100, the user can know not only the value of the condition (parameter value) for realizing the target data, but also the distribution (for example, variance). Thereby, the user can also consider how much margin is expected in order to realize the target value with respect to the condition presented by the analysis device 100.

Next, an operation experiment of the analysis device 100 will be described.

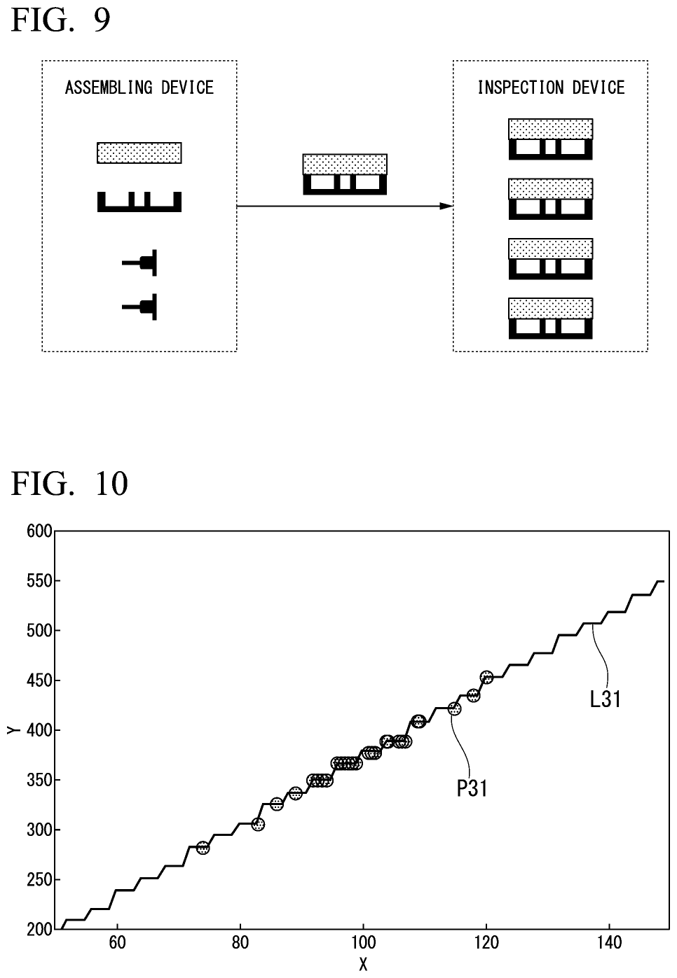

FIG. 9 is a drawing showing an example of an assembly process for which a target value is set. In the assembly process shown in FIG. 9, an assembling device assembles four parts such as an upper part, a lower part, and two screws to produce a product. The product assembled by the assembling device is conveyed to an inspection device. The inspection device performs an inspection when the four products have been loaded.

In this assembly process, the amount of products produced per unit time is data X, and the shipping time of X products (the value of data X) is data Y Further, the number of parameters is assumed to be 2, the working time of the assembling device is assumed to be θ₁, and the working time of the inspection device is assumed to be θ₂.

FIG. 10 is a diagram showing the obtained relationship between X and Y. The horizontal axis of the graph in FIG. 10 represents data X, and the vertical axis represents data Y Also, the target data is indicated by a circle such as the point P31.

The line L31 is a line showing the relationship between X and Y obtained as a result of the relationship analysis.

The line L31 is considered to have a stepwise shape due to a waiting time that arises as a result of the inspection device inspecting the four products upon being conveyed, with the relationship between X and Y being accurately determined. Therefore, the parameters θ₁ and θ₂ indicate the conditions for achieving the target value with high accuracy.

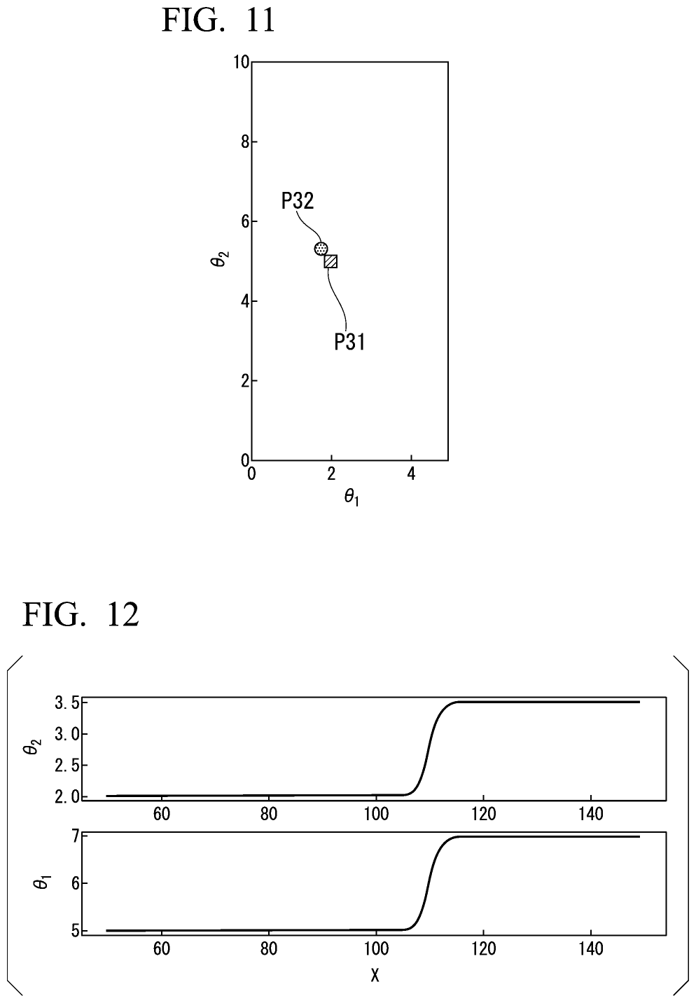

FIG. 11 is a diagram showing parameter values obtained in the experiment. The horizontal axis of the graph in FIG. 11 represents the parameter θ₁ and the vertical axis represents the parameter θ₂.

Point P31 indicates the true value of the parameters. The true value of the parameter here is a parameter value preliminarily assumed as a parameter value for realizing the target value and is, so to speak, an answer in this experiment.

Point P32 indicates the parameter values obtained in the experiment. The point P32 is close to the point P31, and so the parameter values can be calculated appropriately.

FIG. 12 is a diagram showing an example of setting parameter values in a covariate shift experiment.

In the experiment of the above-mentioned assembly process simulation, if the value of X exceeds 110, the true parameter values are set so that both θ₁ and θ₂ have large values (time is required for assembly and inspection).

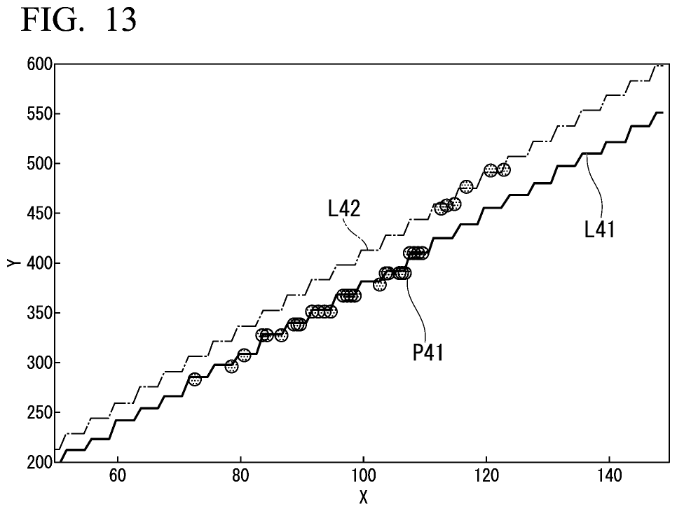

FIG. 13 is a diagram showing the relationship between X and Y obtained in the experiment. The horizontal axis of the graph in FIG. 13 represents the data X, and the vertical axis represents the data Y. Further, the target data is indicated by a circle such as the point P41.

The distribution of target data is q₀(X)=N(X|100,10), centered around X=100. In contrast, it is assumed that the region to be predictive (the region to know the conditions for realizing the target value) is q₁(X)=N(X|120, 10), prediction being desired for the case of X=120 (the conditions for realizing the target value are sought).

The line L41 is a line showing the relationship between X and Y obtained when the covariate shift process is not performed. The line L42 is a line showing the relationship between X and Y obtained when the covariate shift is performed.

The line L41 without the covariate shift accurately approximates the data around X=100, while the line L42 with the covariate shift accurately approximates the data around X=120. In this way, results corresponding to the covariate shift were obtained. The parameter value in this case indicates a condition for realizing the target value around X=120 desired by a user.

Also, as in the case of FIG. 10, a stepwise line is obtained, and in this respect also, the relationship between X and Y is obtained with high accuracy.

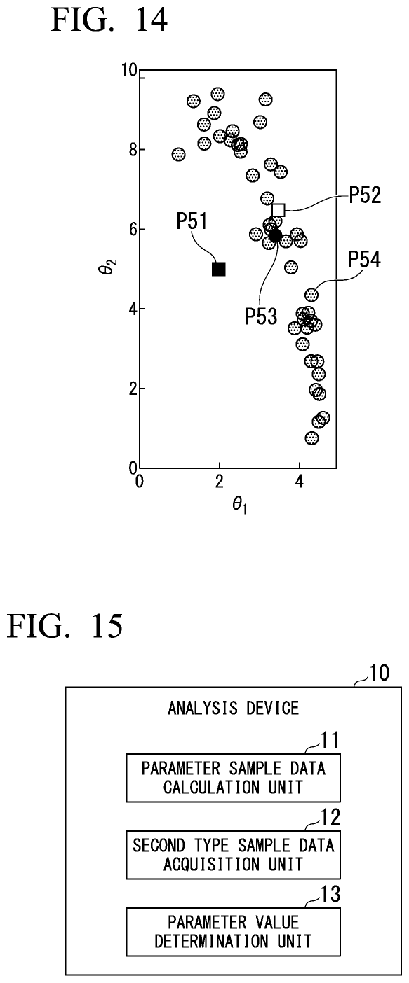

FIG. 14 is a diagram showing the values of the parameters obtained in the covariate shift experiment. The horizontal axis of the graph in FIG. 11 represents the parameter θ₁ and the vertical axis represents the parameter θ₂.

Point P51 indicates the true value of the parameter. Point P52 indicates the true value of the parameter due to the covariate shift. Of the points P51 and P52, point P52 is, so to speak, the answer in this experiment.

Point P53 shows the value of the parameter obtained by the covariate shift. The distribution of the parameter values obtained by kernel herding is indicated by point P54 and the like.

The point P53 is close to the point P52, and the parameter value can be calculated appropriately.

Also, the distribution of parameter values obtained by kernel herding has a large vertical distribution. This indicates that the influence of the value of the parameter θ₂ is greater than the influence of the value of the parameter θ₁. The distribution of the parameter values obtained by kernel herding is rising to the left. This shows that if the value of the parameter θ₁ is improved, some improvement in efficiency is expected.

As described above, sensitivity analysis such as bottleneck analysis can be performed with reference to the distribution of the parameter values obtained by the analysis device 100.

Next, a configuration of the example embodiment of the present invention will be described with reference to FIG. 15.

FIG. 15 is a diagram showing an example of the configuration of the analysis device according to the example embodiment of the present invention. The analysis device 10 shown in FIG. 15 includes a parameter sample data calculation unit 11, a second type sample data acquisition unit 12, and a parameter value calculation unit 13.

With such a configuration, the parameter sample data calculation unit 11 calculates a plurality of pieces of sample data for parameters for a simulator that receives inputs of data of a first type and outputs data of a second type, calculating the sample data based on a temporarily set distribution for the parameters. The second type sample data acquisition unit 12 inputs, to the simulator, the target data of the first type indicating a target value for the data of the first type and sample data for the parameters and obtains the sample data of the second type for each of the plurality of pieces of sample data for the parameters. The parameter value determination unit 13 calculates a weight for each of the plurality of pieces of sample data for the parameters based on the difference between the target data of the second type indicating a target value for the data of the second type and the calculated sample data of the second type and calculates a value for the parameters according to the target data of the first type and the target data of the second type using the calculated weight.

If the parameter value calculated by the parameter value calculation unit 13 is a parameter value with which the simulator approximates the target data with high accuracy, this parameter value indicates a condition for realizing the target value indicated by the target data.

By presenting this parameter value to the user, the analysis device 10 can, with respect to a target value indicated by a user, present the user with conditions for realizing that target value.

In any of the example embodiments, the state indicated by a parameter may be determined based on the value of the parameter calculated by the parameter value calculation unit (the parameter value calculation unit 183 or the parameter value calculation unit 13). Since each parameter numerically represents, for example, the state of a constituent element in the target system, it is possible to find a state in relation to the constituent element in the target system by the process. That is, the analysis device can determine a state for achieving the target value for each constituent element based on the target value for the entire target system. According to this process, it is possible to create a plan for a process performed by each constituent element from the state determined in relation to each constituent element, using the information in which the process related to each component and the state realized by the process are associated.

It should be noted that the process of each unit may be performed by recording a program for executing all or some of the functions of the control unit 180 in a computer-readable recording medium, reading the program recorded in this recording medium into a computer system and executing the program. It should be noted that the “computer system” mentioned here includes an OS and hardware such as peripheral devices.

The “computer-readable recording medium” refers to a portable medium such as a flexible disk, a magneto-optical disk, a ROM, a CD-ROM, or a storage device such as a hard disk built in a computer system. Further, the above-mentioned program may be one for realizing some of the above-mentioned functions, and may be one that can realize the above-mentioned functions in combination with a program already recorded in the computer system.

Although example embodiments of the present invention have been described in detail above with reference to the drawings, the specific configuration is not limited to these example embodiments, and designs or the like within a scope not departing from the gist of the present invention are also included.

Priority is claimed on Japanese Patent Application No. 2018-109879, filed June 7, 2018, the content of which is incorporated herein by reference.

### INDUSTRIAL APPLICABILITY

The present invention may be applied to an analysis device, an analysis method, and a recording medium.

### REFERENCE SYMBOLS

100: Analysis device

110: I/O unit

170: Storage unit

180: Control unit

181: Parameter sample data calculation unit

182: Second type sample data acquisition unit

183: Parameter value calculation unit

191: Kernel mean calculation unit

192: kernel-mean-based parameter calculation unit

193: Parameter predictive distribution calculation unit

194: Second type predictive distribution data calculation unit

1. An analysis device comprising:
at least one memory configured to store instructions; and
at least one processor configured to execute the instructions to:
calculate a plurality of pieces of sample data for parameters for a simulator, based on a temporarily set distribution for the parameters, the simulator receiving inputs of data of a first type and outputting data of a second type;
input, to the simulator, target data of the first type indicating a target value for the data of the first type and each of the plurality of pieces of sample data for the parameters and obtain sample data of the second type for each of the plurality of pieces of sample data for the parameters; and
calculate a weight for each of the plurality of pieces of sample data for the parameters based on the difference between target data of the second type indicating a target value for the data of the second type and the calculated sample data of the second type and calculate, using the calculated weight, a value for the parameters corresponding to the target data of the first type and the target data of the second type.

2. The analysis device according to claim 1, wherein the at least one processor is configured to execute the instructions to:
calculate a kernel mean indicating a posterior distribution of the parameters under the target data of the first type and the calculated sample data of the second type;
calculate sample data of the parameters based on the kernel mean;
calculate a kernel expression of the predictive distribution of the parameters using sample data of the parameters based on the kernel mean; and
calculate sample data according to the predictive distribution of the data of the second type by using the kernel expression of the predictive distribution of the parameters.

3. An analysis method comprising the steps of:
calculating a plurality of pieces of sample data for parameters for a simulator, based on a temporarily set distribution for the parameters, the simulator receiving inputs of data of a first type and outputting data of a second type;
inputting, to the simulator, target data of the first type indicating a target value for the data of the first type and each of the plurality of pieces of sample data for the parameters and obtaining sample data of the second type for each of the plurality of pieces of sample data for the parameters;
calculating a weight for each of the plurality of pieces of sample data for the parameters based on the difference between target data of the second type indicating a target value for the data of the second type and the calculated sample data of the second type; and
calculating, using the calculated weight, a value for the parameters corresponding to the target data of the first type and the target data of the second type.

4. A non-transitory recording medium that records a program for causing a computer to execute the steps of:
calculating a plurality of pieces of sample data for parameters for a simulator, based on a temporarily set distribution for the parameters, the simulator receiving inputs of data of a first type and outputting data of a second type;
inputting, to the simulator, target data of the first type indicating a target value for the data of the first type and each of the plurality of pieces of sample data for the parameters and obtaining sample data of the second type for each of the plurality of pieces of sample data for the parameters;
calculating a weight for each of the plurality of pieces of sample data for the parameters based on the difference between target data of the second type indicating a target value for the data of the second type and the calculated sample data of the second type; and
calculating, using the calculated weight, a value for the parameters corresponding to the target data of the first type and the target data of the second type.
